(19) United States
(12) Patent Application Publication
(10) Pub. No.: US 2012/0128860 A1
(43) Pub. Date: May 24, 2012

(54) PREPARATION OF VEGETABLE MATERIAL AND FOOD PRODUCTS

(76) Inventors: Ali Ebrahim Alawady, Berlin (DE); Bernard Grimm, Berlin (DE); Hendrikus Theodorus W.M. van der Hijden, At Vlaardingen (NL)

(21) Appl. No.: 13/382,021

(22) PCT Filed: Jun. 21, 2010
(86) PCT No.: PCT/EP2010/058709

§ 371 Date: Feb. 10, 2012

(30) Foreign Application Priority Data
Jul. 8, 2009 (EP) 09164910.3

(51) Int. Cl. A23L 1/212; A23L 1/01

(52) U.S. Cl. 426/615; 426/520; 426/438; 426/509

(57) ABSTRACT

The present invention relates to a method for preparation of a vegetable material, wherein a living plant is treated with a cytokinin prior to harvest. The invention also relates to a method for preparation of food products, as well as food products comprising the vegetable material. The advantage of the method is that the vegetable material remains green longer during storage of the food product.

The present invention relates to a method for preparation of vegetable material, and a method for preparation of food compositions. The present invention also relates to food products that contain said vegetable material.

### BACKGROUND OF THE INVENTION

The colour of food products is an important attribute of its appreciability by the consumer. Processing steps in the industrial preparation of the food product, for example a heating step as a preservation aid, as well as storage of the food product during its shelf life may lead to loss of colour of the product. For example, the green colour of leafy vegetables that are ingredients in many food products may become brownish during storage. The mechanism responsible for this colour change, is in general instability of chlorophyll triggered by events during processing, that subsequentially leads to degradation of the chlorophyll during storage of the food product. The major losses of chlorophyll occur during storage rather than during processing.

In order to prevent the degradation of chlorophyll, and therewith colour change of the leafy vegetables from green to brown, various methods have been proposed, which are focused on the stabilisation of chlorophyll in vegetable materials. Most focus has been on treatment of the plants or plant organs after harvesting. Examples of this are variations in heating temperature and time during a preservation or cooking process of the plant, plant organ, and/or food product, and addition of ingredients during processing steps, for example to change the pH of the processing step.

Treatment after Harvest

Conventional processing as for instance used in canning or most drying processes is detrimental for chlorophyll during the thermal phase of the process. Schwartz and Lorenzo (Food Sci. Nutr. 29, 1990, p. 1-17) disclose that a short exposure to higher temperatures is better for chlorophyll retention than prolonged exposure to lower temperatures.

U.S. Pat. No. 4,701,330 discloses a method for preserving the green colour of vegetables stored at refrigeration temperatures wherein vegetables are blanched with water or steam, followed by a vacuum treatment for 30 minutes, and an immersion treatment while under vacuum in an alkaline solution having a pH of about 8.7. Subsequently this is followed by vacuum release, packaging and storing the vegetables in a modified atmosphere of carbon dioxide and nitrogen under refrigerated conditions.

JP 2008-81511 A discloses an aqueous composition containing one or more phytohormone derivatives selected from the cytokinins and one or more saccharides selected from the group of monosaccharides, oligosaccharides, and polysaccharides. This composition can be used to retain the freshness of cut flowers and cut plants parts.

### Treatment Prior to Harvest

In addition to treatment of plants organs or parts post-harvest, also methods have been disclosed to treat plants prior to harvest to improve green colour retention of the plant organs.

US 2004/0082478 A1 discloses treatment of plants with a composition comprising N-acylethanolamine, to achieve a cytokinin-like effect, such as chlorophyll retention.

Similarly, Zaicovski et al. (Postharvest Biol. Technol., 49, 2008, p. 436-439) teach that cytokinin biosynthesis in broccoli can be increased by water stress before harvest, which leads to delay of postharvest yellowing.

GB 1,122,662 discloses methods to improve appearance and/or edibility of plant materials during storage by treating the plant material preferably immediately prior to cutting or harvesting, with a urea derivative like 3,4-dichlorophenyl urea by spraying or dipping in aqueous solutions. Plant materials mentioned are spinach, peas, beans, and several others, as well as flowers. Other treatment steps after harvest of the plant material have not been disclosed.

EP 113 070 A1 discloses the use of substituted nitro and cyanoguanidines to protect fruits or vegetables against deterioration. These fruits or vegetables may be sprayed with an aqueous solution containing a substituted guanidine one to two days before harvest and then either sprayed or dipped in an aqueous solution containing said guanidine within about 24 hours following harvest. The nitro and cyanoguanidines substitute for a cytokinin, N⁶-benzyladenine, and promote growth and enhance rate of chlorophyll biosynthesis. Rate of senescence is decreased, leading to longer retention of green colour of the vegetables. Other treatment steps after harvest of the fruits or vegetables have not been disclosed.

Similarly, U.S. Pat. No. 4,677,226 A discloses alkyl-, alkenyl- and alkynylnitroguanidines as cytokinin plant growth regulants, leading to enhancement of chlorophyll biosynthesis in some tissues or decreased chlorophyll degradation (senescence) in others. Plants are treated with these compounds prior to harvest.

JP 6-169642 A discloses a method to improve the flavour of plant parts and to promote the growth of the plants (especially green tea and leaf vegetables) during cultivation, by irrigation into the root of the plant or by spraying onto the plants an aqueous composition containing L-theanine, alanine, glycine, amino acids, vitamins, nucleic acid, oligosaccharides, auxin and cytokinin (kinetin). No subsequent treatment steps post-harvest have been disclosed.

WO 00/24249 discloses compositions such as culture media to regulate the growth of plants, comprising one or more auxin-like compounds, and possibly also cytokinins such as zeatine, kinetin, and 6-benzylaminopurine. No subsequent treatment steps post-harvest have been disclosed.

### SUMMARY OF THE INVENTION

In spite of all developed technologies, there still is a need to improve the protection of chlorophyll from deterioration during thermal food processing and subsequent storage of the food product. By this protection the amount of chlorophyll that could be retained in the harvested plant or plant organ is higher, and consequently the green colour of the harvested plant or plant organ is retained for longer. When (a part of) the harvested plant or plant organ is applied as an ingredient of an assembled food product, the food product or ingredient of the food products consequently would remain green for a longer time period. This would be favourable for the consumer.

Hence it is an object of the present invention to provide a method for preparation of vegetable material that can be used in food products in order to give the food product a fresh green colour for a long period of time or to retain the green colour of the vegetable material when used as an ingredient in the food product. It is also an object of the present invention to provide a method with which plants can be treated during cultivation in order to prevent discolouration during the subsequent treatment after harvest. It is also an object of the present invention to provide food products which keep a fresh green colour or of which the ingredients keep a fresh green colour longer during storage of the food product.

We have now found that green plants or plant organs (e.g. leaves, stems, fruits) that can be used as ingredient in food products will remain green longer during storage of such food product comprising such a green plant organ or parts of the plant or plant organ, by treating the plant containing that organ with the growth hormone cytokinin prior to harvest. Subsequently after harvest of the plant or the plant organ, the harvested plant or plant organ will be subjected to a heating step, preferably in an aqueous solution, in order to terminate biochemical processes taking place in the organ. This heating step may be performed on the harvested plant or part of the plants or plant organ as such, or may be performed as a pasteurisation or sterilisation step during the preparation process of a food product, after the harvested plant or plant organ has been mixed with other food ingredients. This heating step improves retention of the green colour of the vegetable material as long as possible.

The effect of the treatment of the living plant with a cytokinin and subsequent heating step is not only that the chlorophyll level in the plant or plant organ increases as compared to a situation where no treatment with cytokinin prior to harvest is done. In addition the rate of chlorophyll loss during subsequent storage of the harvested plant or plant organ is also lower than without cytokinin treatment of the plant.

Accordingly in first aspect the present invention provides a method for preparation of a vegetable material, comprising the steps:
a) treatment of a living plant with a cytokinin;
b) harvesting the plant or a part of the plant or an organ of the plant at least 12 hours after step a);
c) heating the plant, or the part of the plant or the organ of the plant at a temperature between 55 and 200° C.

The first aspect of the invention also provides a method for preparation of a food composition, comprising the steps:
a) treatment of a living plant prior to harvest with a cytokinin;
b) harvesting the plant or a part of the plant or an organ of the plant at least 12 hours after step a);
c) heating the plant, or the part of the plant or the organ of the plant at a temperature between 55 and 200° C.;
   and wherein additionally the product from step b) is mixed with at least one food ingredient prior to step c),
   and/or wherein the product from step c) is mixed with at least one food ingredient.

In a second aspect the present invention provides a vegetable material obtainable by the method according to the first aspect of the invention.

The second aspect of the invention also provides a food product comprising the vegetable material obtainable by the method according to the first aspect of the invention.

### DETAILED DESCRIPTION

Unless defined otherwise, all technical and scientific terms used herein have the same meaning as commonly understood by one of ordinary skill in the art. All percentages, unless otherwise stated, refer to the percentage by weight.

Preferred aspects disclosed in connection with the first or second aspect of the present invention, may also be applicable to the other aspects of the invention, mutatis mutandis.

The various features and embodiments of the present invention, referred to in individual sections below apply, as appropriate, to other sections, mutatis mutandis. Consequently features specified in one section may be combined with features specified in other sections, as appropriate. All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the claims.

### Chlorophyll

Chlorophyll is a green pigment found in most plants. Chlorophyll absorbs light most strongly in the blue and red but poorly in the green portions of the electromagnetic spectrum, hence chlorophyll-containing tissues like plant leaves are green. Chlorophyll is vital for photosynthesis, which allows plants to obtain energy from light. Chlorophyll molecules are specifically arranged in and around membrane-bound pigment protein complexes called photosystems which are embedded in chloroplasts. Chlorophyll a and b are the chlorophyll types that are most abundantly present in nature. Also chlorophyll c1, c2, and d are known. The structure of chlorophyll a and chlorophyll b is given below.

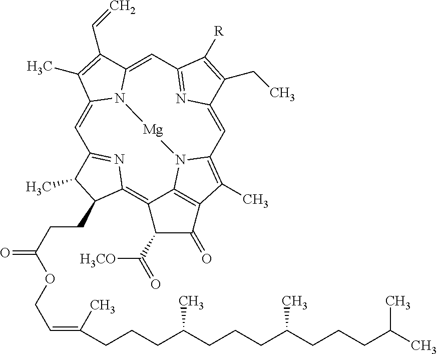

Chlorophyll a: R═CH₃ (methyl)
Chlorophyll b: R═CHO (carbonyl)

In the context of the present invention, the term ‘chlorophyll’ relates to chlorophyll a, b, c1, c2, and d.

When chlorophyll degrades, the green colour disappears. Chlorophyll degradation in plants occurs via a cascade of coloured intermediates that finally are converted into colourless compounds. The coloured intermediates (like pheophytin, pheophorbide) range in colour from olive green to brown, and consequently the plant loses its fresh green colour and can adopt olive green and brown colours as well. Causes of degradation of chlorophyll are for example heat, as well as senescence of the plants.

### Cytokinins

Cytokinins are plant growth hormones that are derivatives of the purine adenine. There are two types of cytokinins: adenine-type cytokinins represented by kinetin, zeatin and 6-benzylaminopurine, as well as phenylurea-type cytokinins like diphenylurea or thidiazuron. There is no evidence that the phenylurea cytokinins occur naturally in plant tissues and are considered to be synthetic cytokinins.

Cytokinins are the most important hormones that delay senescence and promote chlorophyll synthesis and chloroplast biogenesis in higher plants. They are described to have direct impact on chlorophyll a stability (S. Hortensteiner, Cellular and Mol. Life. Sci., 56, 1999, p. 330-347), delaying senescence and therefore preventing chlorophyll from breaking down. Senescence is the general term describing processes which take place during aging of an organism. Exogenous application of cytokinins to plant tissues results in a variety of responses including delay in senescence, maintenance of chloroplast activity, decline chlorophyll degradation, the production of protein and nucleic acid synthesis and mobilization of nutrients (J. S. An et al., J. Food Engin. 2006, p. 951-957). Studies on chlorophyll degradation during the post-harvest phase in broccoli, showed that the use of 6-benzylaminopurine slowed the chlorophyll degradation rate and had a correlation to the degreening rate, suggesting that this hormone could be a suitable biochemical agent to prevent loss of colour in vegetables (M. L. Costa et al., Postharvest Biol. Technol., 35, 2005, p. 191-199).

More than 200 natural and synthetic cytokinins are known. The natural occurring active cytokinins tend to be derived from adenine and have either an aromatic or isoprene derived side chain on the N6 terminus. This enables the split of cytokinins into two main classes, viz. aromatic cytokinins and isoprenoid cytokinins.

### Examples of Aromatic Cytokinins:

a. ortho-topolin (oT)

b. meta-topolin (mT)

c. ortho-methoxytopolin (MeoT)

d. meta-methoxytopolin (MemT)

e. 6 benzyl-amino-purine (BAP), see figure below:

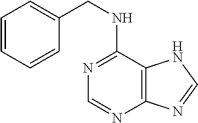

### Examples of Isoprenoid Cytokinins:

a. cis-zeatin (cZ) and trans-zeatin (tZ), see structures below

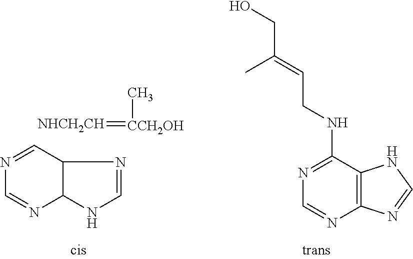

b. N6-(D2-isopentenyl)adenine (iP)

c. dihydrozeatin (DZ), in which case the double bond in the side group of zeatin has been hydrogenated

d. kinetin (6-furfuryl amino purine):

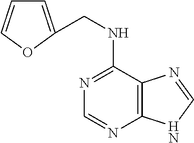

(C₁₀H₉N₅O; M_{W} 215.21; synonyms: 6-furfurylaminopurine and N⁶-furfuryladenine)

Kinetin was the First Cytokinin Discovered and so Named Because of the Compounds ability to promote cytokinesis (cell division). Though it is a natural compound, it is not made in plants, but is a compound from autoclaved herring sperm and is therefore usually considered a ‘synthetic’ cytokinin (meaning that the hormone is synthesized somewhere other than in a plant).

Physiological functions of cytokinin are:
stimulates cell division;
stimulates morphogenesis (shoot initiation/bud formation) in tissue culture;
stimulates the growth of lateral buds-release of apical dominance;
stimulates leaf expansion resulting from cell enlargement;
may enhance stomatal opening in some species;
promotes the conversion of etioplasts into chloroplasts via stimulation of chlorophyll synthesis;
and delays leaf senescence

The steps in cytokinin signaling are the following:
a cytokinin, like zeatin, binds to a receptor protein embedded in the plasma membrane of the cell;
the internal portion of the receptor then attaches a phosphate group to a protein in the cytosol;
this protein moves into the nucleus where it activates one or more nuclear transcription factors;
these bind to the promoters of genes;
transcription of these genes produces mRNAs that move out into the cytosol;
translation of these mRNAs produces the proteins that enable the cell to carry out its cytokine-induced function.

### Method for Treatment of the Plants

In a first aspect of the present invention provides a method for preparation of a vegetable material, comprising the steps:
a) treatment of a living plant prior to harvest with a cytokinin;
b) harvesting the plant or a part of the plant or an organ of the plant at least 12 hours after step a);
c) heating the plant, or the part of the plant or the organ of the plant at a temperature between 55° C. and 200° C.

A vegetable material in the context of the present invention is defined to be a material of vegetable origin. The vegetable material can be a whole plant, or a part of a plant like for example stems and leafs, or a plant organ like a leaf or the fruit of a plant.

In step a) a living plant is treated, which is understood to mean that the plant or plant organ is still being grown and not yet harvested. The plant can be cultivated by any method which is common in agriculture, like on a field or in a greenhouse, or by any other suitable method known in the art. The plant may also be cultivated on hydroponics, wherein the plants are grown using mineral nutrient solutions, without soil. The plants may be cultivated with their roots in the mineral nutrient solutions or in an inert medium like mineral wool.

The treatment of the plant with a cytokinin in step a) may occur more than once, for example the plant may be treated twice on two days, wherein the days may be consecutive days or not consecutive days. The treatment could suitably occur three, four, five or more times.

Preferably in this method, the cytokinin comprises kinetin. The cytokinin may be combined with the other classes of growth hormones, such as abscisic acid, auxins, ethylene and gibberellins. Preferably, a combination of kinetin with any of the other growth hormones, such as abscisic acid, auxins, ethylene and gibberellins could be used. Also a combination of any of the cytokinins mentioned above could be used in step a of the present invention.

Preferably, in step a) a cytokinin in aqueous solution is sprayed onto the living plant. Spraying may be performed by any spraying method which is suitable or commonly used in plant cultivation. Preferably the concentration of the cytokinin in the aqueous solution is between from 0.01 to 10 millimole per liter, more preferred from 0.1 to 5 millimole per liter, more preferred from 0.5 to 2 millimole per liter. When the cytokinin is sprayed onto the plant, the cytokinin is taken up by the plant from it's surface.

Alternatively, another preferred method for the treatment of the living plant with a cytokinin in step a), is that when the plant is grown on hydroponics, the cytokinin is comprised in the mineral nutrient solutions with which the plants are fed. Subsequently the cytokinin can be taken up by the plant from the medium.

Another preferred method for treatment of the living plant with a cytokinin in step a), is injecting a medium comprising cytokinin into the veins of the leafs or other parts of the plant. Preferably the concentration of the cytokinin in the medium is between from 0.01 to 10 millimole per liter, more preferred from 0.1 to 5 millimole per liter, more preferred from 0.5 to 2 millimole per liter.

The harvesting of the plant or plant organ in step b) takes place at least 12 hours after the treatment step a). This time is required in order to give the plant the time to take up the cytokinin and assimilate the growth hormone. The harvest may for example also take place 24 hours after treatment in step b), or 2 days after treatment, or 3 days. Preferably the plant is harvested maximally 4 or 5 days after treatment.

The maximum time period between steps b) and c) depends on the type of plant, and may preferably range from one day between harvest in step b) and heating in step c) for certain plants, up to preferably a few weeks for other plants. This not only depends on the type and kind of plant or plant organ, but also on the storage conditions of the harvested material prior to step c), like temperature, humidity, composition of the gas atmosphere (air, nitrogen).

The plant or the part of the plant or the organ of the plant that is harvested may be heated in step c) as harvested, or alternatively may be treated after harvest and prior to step c), for example by washing, cooling, freezing, cutting in pieces, milling, grinding, drying or any other treatment, or a combination of any of these treatments, which is common in the art.

Preferably in step c) the heating is done by frying at a temperature between 110° C. and 200° C. Frying means that the heating is done in oil, wherein the oil preferably is an edible oil or fat. In the context of the present invention the term edible oil or fat generally relates to triglycerides from vegetable or animal origin, for example, but not limited to sunflower oil, palm oil, or tallow. In addition, the oil may also contain traces of diglycerides, monoglycerides, or free fatty acids. The terms edible oil or fat, and triglycerides are known to the skilled person. More preferably the heating step in such a frying step is done at an oil temperature between 120° C. and 190° C., more preferred between 140 and 180° C. Frying may be performed as a shallow frying or a deep frying method. Shallow frying involves the heating of the vegetable material in a thin layer of oil in a pan or similar vessel, while deep frying involves the immersion of the vegetable material in the oil.

In an alternative preferred method, in step c) the heating is done in an aqueous solution at a temperature between 55° C. and 150° C. In that case, in step c) the temperature preferably is preferably between 60° C. and 150° C., more preferably between 55° C. and 140° C., more preferably between 60° C. and 140° C., even more preferably between 60° C. and 120° C., and most preferably between 70° C. and 95° C.

During the heating step the biochemical processes in the harvested plant or plant organ, which usually (partly) continue after harvest, are terminated. If the heating step is carried out as a unit operation, the duration of the heating step c) could range from a few seconds (e.g. 2, 3, 4, 5, 6, 7, 8, 9, 10 seconds) to 30 minutes, more preferably from 5 seconds to 20 minutes, more preferably from 8 seconds to 10 minutes, more preferably from 20 seconds to 10 minutes, more preferably from 30 seconds to 10 minutes, most preferably from 1 minute to 10 minutes. Typically when the temperature is relatively high, the heating time will be short and vice versa. In the whole process the exposure to heat of the vegetable material may be much longer than only in the unit operation step c) (if step c) is carried out as a unit operation), such as but not limited to from 10 to 200 minutes.

The actually required inactivation temperature and time are dependent on the plant or organ that is used in the present invention. Some sensitive enzymes in plants are already being inactivated at temperatures lower than 40° C., while others need temperatures of 50, 60, or 70, or even 100° C. or higher. Most enzymes are inactivated at 100° C., but some need higher temperatures for full inactivation. Biochemical processes are usually terminated due to loss of integrity of the cell membrane (around 50° C.) and due to enzyme inactivation. The thermal treatment is also relevant for microbial safety, as potential pathogens need to be killed: pasteurisation temperatures range from 70 to 95° C., whereas sterilisation occurs at higher temperatures, typically but not limited to 120 to 150° C.

If according to a preferred method, the heating in step c) is performed in aqueous solution, then preferably the pH in step c) has a value between 3 and 11. More preferred, the aqueous solution in step c) has a pH from 6.5 to 11, more preferred from 7 to 11, even more preferred from 7.2 to 10, and most preferred from 8 to 10. Preferably at these pH ranges, the pH is kept constant by a buffered solution. By this buffering at the relatively high pH values, the retention of chlorophyll may be increased as compared to an unbuffered heating step. This effect is especially pronounced at high soaking temperatures of step c). Alternatively, the pH in step c) is preferably from 3 to 6.5, more preferred from 3.5 to 6, more preferred from 4 to 5.5, more preferred from 4.5 to 5. This pH in step c) may be obtained by heating the vegetable material, which may result into a pH within the sour range as indicated here.

After step c) the vegetable material may be cooled, for example by immersion of the vegetable material in a water bath at a temperature between for example 2 and 10° C., or for example by cooling in air, with or without forced air circulation. Alternatively after step c), the vegetable material may be treated by washing, freezing, cutting in pieces, milling, grinding, drying or any other treatment, or a combination of any of these treatments, which is common in the art.

### Plants and Plant Organs

Plants that are suitable for use in the present invention include any plant, but especially preferred are green and edible plants or plant organs, as described by the general term ‘fruit and vegetables’.

A vegetable is a plant that is cultivated for an edible part, such as the root of a beet, the leaf of spinach, or the flower buds of broccoli or cauliflower. A vegetable is generally seen as any savoury or less sweet plant product. Usually in culinary context the term vegetable excludes sweet fruits, seeds, nuts, grains, and herbs and spices.

The definition of fruit depends on whether the term is used in culinary or biological (or botanical) context. In culinary terms, fruit is usually a sweet tasting plant reproduction organ, like an apple, or strawberry. Some fruits in botanical sense are in culinary context seen as vegetables, because they are not (or less) sweet, for example cucumber and tomato.

In biological context a seed is a small embryonic plant enclosed in a covering called the seed coat, for reproduction of the plant. In culinary sense, edible seeds include seeds that are directly foodstuffs, as well as seeds that are used to make derived products. Some examples of seeds are beans (or legumes), which are protein-rich soft seeds. Cereals (or grains) are grass-like crops that are harvested for their dry seeds. These seeds are often ground to make flour. Cereals provide almost half of all calories consumed in the world. Examples are rice and wheat. Nuts are botanically a specific type of fruit but the term is also applied to many edible seeds that are not botanically nuts. In culinary context a nut is any hard, oily, and shelled plant product.

A herb is a plant that usually is valued for flavor, scent, or other qualities. In culinary context, herbs originate from leafy green parts of a plant, while spices generally originate from other parts of the plant, including seeds, berries, bark, root, fruit, dried leaves and roots. Culinary herbs are distinguished from vegetables in that, like spices, they are used in small amounts and provide flavor rather than substance to food. Culinary herbs can originate from herbaceous plants (like chive), shrubs (such as rosemary and thyme (which is a small shrub)) or trees (such as bay laurel).

Another property of the plants is that they should belong to the group of photosynthesising (or chlorophyll-containing) plants. The following edible plants and plant organs are suitable for use within the scope of the present invention, however, the invention is not limited to the plants and plant organs mentioned as examples here.

### Plants

The plants indicated here as examples to be suitable in the present invention are mentioned in their culinary context, and not ordered in a botanical way.
broccoli (Brassica oleracea, Italica cultivar group);
other species from the Brassica genus, e.g. cabbage;
spinach;
herbs such as but not limited to parsley, sage, rosemary, thyme, oregano, basil, and chive;
leek and other plants from the alliaceae botanical family;
green bell pepper (also known as paprika);
and legumes like French beans, peas, and green beans.

In addition to these exemplified plants, which are cultivated on land, the following aquatic plants are also considered to be within the scope of the present invention:
green algae (chlorophytae), which are photosynthetic;
and seaweeds, which belong to the green algae.

When cultivating green algae and/or seaweeds, for example in a basin, the cytokinin can be applied to the green algae and/or seaweeds as part of a nutrient medium with which the green algae and/or seaweeds are fed.

### Plant Organs

The six major plant parts (in botanical context) are roots, stems, leaves, flowers, fruits, and seeds. The following plant organs are examples of organs which are suitable in the context of the present invention:
leaves (defined as the plant organ specialised for photosynthesis), including needles;
flowers and flower heads;
buds;
seeds;
pods;
fruits;
tubers and roots;
and stem.

Preferably, the organ in step c) is a green organ. Preferably the plant is an edible plant, more preferably selected from the group consisting of herbs, broccoli, spinach, peas, and green bell pepper, and combinations thereof.

### Preparation of Food Product

The first aspect of the invention also provides a method for preparation of a food composition, wherein the vegetable material according to the invention is prepared or used. Hence the first aspect of the invention also provides a method for preparation of a food composition, comprising the steps:
a) treatment of a living plant prior to harvest with a cytokinin;
b) harvesting the plant or a part of the plant or an organ of the plant at least 12 hours after step a);
c) heating the plant, or the part of the plant or the organ of the plant at a temperature between 55° C. and 200° C.;
   and wherein additionally the product from step b) is brought into contact with at least one food ingredient prior to step c),
   and/or wherein the product from step c) is brought into contact with at least one food ingredient.

Preferred aspects of the invention for preparation of a vegetable material, can be applied mutatis mutandis to the method for the preparation of a food composition.

Preferably in step c) the heating is done by frying at a temperature between 110° C. and 200° C. Frying means that the heating is done in oil, wherein the oil preferably is an edible oil or fat. More preferably the heating step in such a frying step is done at an oil temperature between 120° C. and 190° C., more preferred between 140 and 180° C. Frying may be performed as a shallow frying or a deep frying method. Shallow frying involves the heating of the vegetable material in a thin layer of oil in a pan or similar vessel, while deep frying involves the immersion of the vegetable material in the oil.

In an alternative preferred method, in step c) the heating is done in an aqueous solution at a temperature between 55° C. and 150° C. In that case, in step c) the temperature preferably is preferably between 60° C. and 150° C., more preferably between 55° C. and 140° C., more preferably between 60° C. and 140° C., even more preferably between 60° C. and 120° C., and most preferably between 70° C. and 95° C.

In this method according to the first aspect of the invention, the harvested plant or the part of the plant or the plant organ from step b) is either brought into contact with at least one food ingredient, and preferably mixed with the food ingredient, and this composition is subsequently heated at a temperature between 55 and 200° C. Or alternatively, the bringing into contact, optional mixing and subsequent heating with a food ingredient is carried out the other way around: first heating of the harvested plant or the part of the plant or the plant organ at a temperature between 55 and 200° C., followed by bringing this heated plant or plant organ into contact with at least one food ingredient.

A food ingredient is an ingredient of a food product or food composition, and these ingredients incorporate all ingredients which are commonly known to the skilled person. Bringing into contact should be understood in it's broadest sense. For example if the vegetable material is broccoli, then bringing into contact can be understood to be that the broccoli is packed with other elements of a ready meal, or may be mixed with other vegetable in a vegetable dish. On the other hand, if the vegetable material for instance is a herb like basil, then the herb may be mixed with other food ingredients, or be sprinkled on a food product.

Before bringing the harvested plant or the part of the plant or the plant organ into contact with a food ingredient, it may need to be cut in small pieces, or may undergo a treatment common in the art, such as but not limited to a washing step, cooling step, or drying. These optional additional steps may be carried out before or after the heating step c).

The at least one food ingredient with which the harvested plant or the part of the plant or the plant organ from step b) is brought into contact, can be in a ‘raw’ form, thus not yet formulated as a ready food product. In that case the heat treatment of the harvested plant or plant organ may be performed as for example a pasteurisation step which is required to keep the food product microbiologically safe and stable. This way the vegetable material according to the invention is prepared by such a pasteurisation of the entire food product. The food product then comprises the vegetable material according to the invention.

The vegetable material obtained after step c) of the method according to the invention could also be brought into contact with one or more food ingredients in ready form. This means that the food composition into which the plant or plant organ is mixed is already a food product ready for consumption, and to which for example herbs are added which are obtained according to the present method of the invention. This then leads to longer retention of the green colour of the herbs during the shelf life of the food product.

The method for preparation of a food composition according to the first aspect of the invention can be regarded to be a preferred embodiment of the method for preparation of a vegetable material according to the first aspect of the invention. The method for preparation of a food product comprises the method for preparation of a vegetable material according to the first aspect of the invention, and wherein additionally the product from step b) is brought into contact with at least one food ingredient prior to step c), and/or wherein the product from step c) is brought into contact with at least one food ingredient.

### Food Products

In a second aspect, the present invention provides a vegetable material obtainable by the method according to the first aspect of the invention. This vegetable material preferably is used as a food product or as an ingredient of a food product. Hence the second aspect of the invention preferably provides a food product comprising the vegetable material according to the invention. Referring back to the examples above, if the vegetable material is for example broccoli, then the food product may be the broccoli flower heads as such. If the vegetable material is for example a herb like basil, then the food product may be a product containing pieces of basil sprinkled on the surface of the product.

Such a food product could be produced by mixing the (part of) a plant, and/or (part of) a plant organ with other food ingredients. Alternatively, the food product can be produced by the preferred method according to the first aspect of the invention.

A wide range of food products is suitable as a carrier for the harvested plant or plant organs of the method of the present invention. Preferred examples of these are soup, dressing, beverage, spread, or herb composition.

Preferred examples of such food products are cereal bars, cookies and biscuits, confectionery products, condiments, confectionary, beverages, desserts, snacks, dressings, mayonnaise, sauces, spreads and cheeses with herbs (soft cheese, hard cheese), dairy drinks, fruit drinks or juices, vegetable drinks or juices, combinations of dairy, and/or fruit, and/or vegetable drinks.

Especially preferred food products according to the present invention are soups, e.g. pea soup or any other soup comprising herbs which have been obtained according to the method of the invention.

Other assembled food products which are within the scope of the present invention are ready made meals, as well as frozen food products.

In case the food product is a beverage, more specifically a fruit drink, or combination of fruit and dairy drink, it preferably comprises at least 10% by weight of the composition of a fruit component, wherein the fruit component is selected from fruit juice, fruit concentrate, fruit juice concentrate, fruit puree, fruit pulp, comminuted fruit, fruit puree concentrate, and combinations thereof. Examples of such fruit components are orange juice, apple juice, grape juice, peach pulp, banana pulp, apricot pulp, concentrated orange juice, mango pulp, concentrated peach juice, raspberry puree, strawberry puree, apple pulp, raspberry pulp, concentrated grape juice, concentrated aronia juice, concentrated elderberry juice. Preferably such a beverage comprises at least 30% by weight of the beverage of said fruit component, more preferred at least 40% by weight of the beverage of said fruit component. These amounts are calculated as if undiluted, non-concentrated fruit juices and purees and the like are used. Thus, if 0.5% by weight of a 6-fold fruit concentrate is used, the actual amount of fruit component incorporated is 3% by weight of the beverage. Any commonly available fruit component might be used in the beverages according to the invention, and may be selected from one or more of the following fruit sources: citrus fruit (e.g. orange, tangerine, lemon or grapefruit); tropical fruit (e.g. banana, peach, mango, apricot or passion fruit); red fruit (e.g. strawberry, cherry, raspberry or blackberry), or any combination thereof.

Preferably the beverage is a beverage made from vegetable juice, wherein one or more of such vegetables may be treated according to the first aspect of the invention. Examples of such vegetable beverages are mini drinks containing carrot juice, combined with the juice of green vegetables.

Other preferred food products according to the invention are herbal compositions like herb pastes. Such compositions may comprise one or more pureed, crushed or ground herb(s), optionally combined with oil, and/or salt and/or other ingredients like cheese, seeds, and vinegar. Examples of herbs suitable for such kind of compositions have been given herein before. An example of such a herb paste is pesto, which traditionally contains ground basil and pine nuts, garlic, extra virgin olive oil, and grated hard cheese.

Alternatively, the food product preferably is a spread such as a water-in-oil emulsion (an oil continuous emulsion), for example a margarine or low fat margarine type food product. A spread may also be an oil-in-water (water-continuous) emulsion, like dairy spreads or soft cheese spreads. Suitably the total triglyceride level of such a spread may range from about 10% by weight to 85% by weight of the composition, more preferred from 20% to 70% by weight, most preferred from 30% to 60% by weight of the composition. Such spreads may contain herbs and spices, wherein the herbs have been obtained according to the first aspect of the present invention.

The food product may be dried and contain less than 40% water by weight of the composition, preferably less than 25%, more preferably from 1 to 15%. Alternatively, the food may be substantially aqueous and contain at least 40% water by weight of the composition, preferably at least 50%, more preferably from 65 to 99.9%.

In addition, the food preferably comprises nutrients including carbohydrate (including sugars and/or starches), protein, fat, vitamins, minerals, phytonutrients (including terpenes, phenolic compounds, organosulfides or a mixture thereof) or mixtures thereof. The food may be low calorie (e.g. have an energy content of less than 100 kCal per 100 g of the composition) or may have a high calorie content (e.g. have an energy content of more than 100 kCal per 100 g of the composition, preferably between 150 and 1000 kCal). The food may also contain salt, flavours, colours, preservatives, antioxidants, non-nutritive sweetener or a mixture thereof.

### EXAMPLES

The following non-limiting examples illustrate the present invention.

### Methods

Determination of chlorophyll contents of fresh leaves using a spectrophotometer. Procedure:
1. Homogenisation of plant tissue (100 mg) in liquid nitrogen. For each data point at least three biological samples were harvested.
2. Addition of 400 microliter acetone in 10 micromolar KOH and subsequent vortexing
3. Centrifugation of the homogenate at 13,000 rpm for 10 min to remove cell debris and proteins
4. Transfer of the supernatant into new test tubes
5. Addition 200 microliter of extraction mixture to the pellet as mentioned above and vortexing
6. Centrifugation of the homogenate at 13,000 rpm for 10 min
7. Mix of the supernatant with the supernatant from step 4
8. Repeat of steps 5-7 three times until the pellet is completely white
9. Dilution of the sample 1:10 in acetone and measurement of absorption at 664, 646/7 and 750 nm in a spectrophotometer. All absorbance measurements at the indicated wavelength need subtraction of the absorbance at 750 nm. Calculation of the chlorophyll contents by comparing with calibration curves.

Determination of chlorophyll contents of leaves by HPLC. Procedure:
1. Homogenisation of 100 mg plant material in liquid nitrogen in a test tube
2. Addition of 500 microliter acetone with 10 micromolar KOH and vortexing.
3. Centrifugation of the suspension for 10 min at 4° C. at 13.000 rpm.
4. The supernatant is transferred into new test tube
5. Addition of 500 microliter acetone to the pellet and resuspension of the pellet
6. Centrifugation for 10 min at 4° C. at 13.000 rpm.
7. The supernatant is combined with the supernatant from step 4
8. The samples are vortexed and centrifuged for 10 min at 4° C. at 13,000 rpm.
9. A 40 microliter aliquot of the extract is mixed with 160 microliter water
10. The sample is transferred into a HPLC vial
11. An aliquot of 10-100 microliter is injected into the HPLC column (RP C18 column)
12. Running buffers: Acetonitril/H₂O/triethylamine (1798:200:2) and ethyl acetate

Objective of the experiments: to combine effects of pre-harvest treatment of tobacco plants with the growth hormone kinetin and subsequently soaking with a buffer solution on the stability of chlorophyll after heat treatment followed by different storage periods.

A 1 mM kinetin solution in water was made by dissolving kinetin dropwise with 10 microliter 1M NaOH, then the solution was neutralized to pH 7.0 with HCl. This 1 mM kinetin aqueous solution was injected into the leaves of growing tobacco plants (Nicotiana tabacum). The application of cytokinin was repeated once a day for five successive days. At day 7, tobacco leaves were harvested and stored in aluminium foils. Control plants were treated with the same solution at pH 7.0 (in water), but without kinetin.

After harvest, leaves of the harvested plants (both treated with cytokinin, as well as the control plants) were separated in batches, which were subsequently treated at different temperatures in one the following ways:
1. leaves were soaked in tap water during 1 minute at room temperature;
2. leaves were soaked in a buffer solution of pH 7.2 during 1 minute at room temperature;
3. leaves were soaked in tap water during 1 minute at 70° C.;
4. leaves were soaked in a buffer solution of pH 7.2 during 1 minute at 70° C.;
5. leaves were soaked in tap water during 1 minute at 90° C.;
6. leaves were soaked in a buffer solution of pH 7.2 during 1 minute at 90° C.;

Immediately after each of these steps, the soaked leaves were cooled shortly in a cold tap water bath at 3° C.

The aqueous buffer solution contained 137 mM NaCl, 2.7 mM KCL, 10 mM Na₂HPO₄ and 2 mM KH₂PO₄, and was adjusted to pH 7.2 with more hydrogen phosphate or dihydrogenphosphate if required.

Finally the chlorophyll content of the leaves was quantified after storage in tissue papers at 4° C. in the dark at various moments in time. Leave samples were taken immediately after heating and cooling steps described above, and after 0, 3, 7, 10, 14, and 27 days of storage (see Table 1).

### Results of Soaking at Room Temperature

TABLE 1
Experimental setup and results at soaking temperature at room temperature - Content of
chlorophyll a and b in tobacco leaves (in micromole chlorophyll per gram fresh
weight leaves)

| | pre- | | chlorophyll level after xx days storage | | | | | | | reduction |
|---|---|---|---|---|---|---|---|---|---|---|
| sample | harvest | soaking | [micromole per gram fresh weight] | | | | | | | after |
| code | treatment | solution | 0 d | 3 d | 7 d | 10 d | 14 d | 20 d | 27 d | 27 d |
| C RT | water | water | 14.5 | 14 | 12.3 | 10 | 9 | 8 | 7.2 | 50% |
| B RT | water | buffer | 13.5 | 14 | 12.5 | 12.5 | 11.5 | 10.2 | 8 | 38% |
| | | pH 7.2 | | | | | | | | |
| K RT | cytokinin | water | 18 | 17.8 | 17.2 | 16.5 | 16.2 | 16 | 16 | 9% |
| | 5 days | | | | | | | | | |
| B K RT | cytokinin | buffer | 18.5 | 17.5 | 16.5 | 15.5 | 16 | 15.5 | 15 | 17% |
| | 5 days | pH 7.2 | | | | | | | | |

Chlorophyll content in the room temperature treated control leaves (not pre-treated with cytokinin and soaked in water at RT) was reduced by about 50% after 27 days, whereas the chlorophyll reduction of the leaves heat-treated in the presence of the buffer was only about 40%.

The effect of the cytokinin pre-treatment was much stronger: less then 10% of the chlorophyll content was lost over after 27 days.

Moreover the starting levels immediately after soaking were significantly higher.

Combination of cytokinin pre-treatment and buffer treatment did not enhance the effect of cytokinin only (see Table 1).

From this experiment the following conclusions can be drawn:
treatment with cytokinin leads to higher content of chlorophyll per fresh weight immediately after soaking of the leaves;
without cytokinin treatment, soaking in a buffered solution at room temperature as compared to an unbuffered soaking step leads to lower chlorophyll loss;
cytokinin treatment leads to reduction of the rate of chlorophyll degradation, both when soaked in buffered or unbuffered solutions.

### Results at a Soaking Temperature of 70° C.

TABLE 2
Experimental setup and results of heating step at a soaking temperature of 70° C. -
Content of chlorophyll a and b in tobacco leaves (in micromole chlorophyll per gram
fresh weight leaves)

| | pre- | | chlorophyll level after xx days storage | | | | | | | reduction |
|---|---|---|---|---|---|---|---|---|---|---|
| sample | harvest | soaking | [micromole per gram fresh weight] | | | | | | | after |
| code | treatment | solution | 0 d | 3 d | 7 d | 10 d | 14 d | 20 d | 27 d | 27 d |
| C 70 | water | water | 12.5 | 10.5 | 8.8 | 7 | 6 | 5 | 2.5 | 79% |
| B 70 | water | buffer | 14.5 | 14.5 | 14 | 14 | 13 | 12 | 11 | 24% |
| | | pH 7.2 | | | | | | | | |
| K 70 | cytokinin | water | 17.5 | 17 | 16.5 | 16.5 | 16 | 16 | 15.5 | 11% |
| | 5 days | | | | | | | | | |
| B K 70 | cytokinin | buffer | 18 | 17.5 | 17.2 | 17 | 17 | 16.8 | 16 | 11% |
| | 5 days | pH 7.2 | | | | | | | | |

The control leaves (C 70) have lost about 80% of their chlorophyll content after 27 days storage, whereas the losses for the cytokinin pre-treated leaves were less than 15% over the same storage period (Table 2). The combination with the buffer only had a negligible effect on the chlorophyll retention.

From this experiment at a soaking temperature of 70° C. the conclusions are similar as at a soaking step at room temperature, and the effects are more pronounced:
treatment with cytokinin leads to higher content of chlorophyll immediately after soaking of the leaves;
without cytokinin treatment, soaking in a buffered solution at room temperature as compared to an unbuffered soaking step leads to a lower chlorophyll loss;
cytokinin treatment leads to reduction of the rate of chlorophyll degradation as compared to the control where the plants are not treated with cytokinin; both when soaked in buffered or unbuffered solutions.

### Results at a Soaking Temperature of 90° C.

TABLE 3
Experimental setup and results of heating step at a soaking temperature of 90° C. -
Content of chlorophyll a and b in tobacco leaves (in micromole chlorophyll per gram
fresh weight leaves)

| | pre- | | chlorophyll level after xx days storage | | | | | | | reduction |
|---|---|---|---|---|---|---|---|---|---|---|
| sample | harvest | soaking | [micromole per gram fresh weight] | | | | | | | after |
| code | treatment | solution | 0 d | 3 d | 7 d | 10 d | 14 d | 20 d | 27 d | 27 d |
| C 90 | water | water | 9.5 | 8 | 6.5 | 6 | 5 | 3 | 2 | 79% |
| B 90 | water | buffer | 13 | 12 | 11 | 9.8 | 9 | 9.5 | 8 | 38% |
| | | pH 7.2 | | | | | | | | |
| K 90 | cytokinin | water | 15 | 13.5 | 12.5 | 11 | 9.8 | 8.8 | 7.5 | 50% |
| | 5 days | | | | | | | | | |
| B K 90 | cytokinin | buffer | 18 | 17.5 | 17 | 16.5 | 16 | 15.5 | 15 | 20% |
| | 5 days | pH 7.2 | | | | | | | | |

At 90° C. the losses of the control are comparable to those of the 70° C. treatment, but starting values at day 0 are somewhat lower. The effect of the buffer is comparable to that of the 70° C. soak, but the effect of cytokinin is less pronounced. In combination with buffer the chlorophyll losses are less than 20% (Table 3).

From this experiment at a soaking temperature of 90° C. the conclusions are similar as at a soaking step at 70° C., and the effects are more pronounced:
treatment with cytokinin leads to higher content of chlorophyll immediately after soaking of the leaves;
without cytokinin treatment, soaking in a buffered solution at room temperature as compared to an unbuffered soaking step leads to a much lower chlorophyll loss;
cytokinin treatment leads to reduction of the rate of chlorophyll degradation as compared to the control where the plants are not treated with cytokinin; especially a pronounced effect is observed in the buffered solution.

1. A method for preparation of a vegetable material, comprising the steps:
a) treatment of a living plant with a cytokinin;
b) harvesting the plant or a part of the plant or an organ of the plant at least 12 hours after step a);
c) heating the plant or the part of the plant or the organ of the plant at a temperature between 55° C. and 200° C.

2. A method according to claim 1, wherein the cytokinin comprises kinetin.

3. A method according to claim 1, wherein in step a) a cytokinin in aqueous solution is sprayed onto the living plant.

4. A method according to claim 1, wherein the concentration of cytokinin in aqueous solution is from 0.01 to 10 millimole per liter.

5. A method according to claim 1, wherein in step c) the heating is done by frying at a temperature between 110° C. and 200° C.

6. A method according to claim 1, wherein in step c) the heating is done in aqueous solution at a temperature between 60° C. and 150° C.

7. A method according to claim 6, wherein the aqueous solution in step c) has a pH from 6.5 toll.

8. A method according to claim 6, wherein the aqueous solution in step c) has a pH from 3 to 6.5.

9. A method according to claim 1, wherein the duration of step c) is from 1 to 10 minutes.

10. A method according to claim 1, wherein the organ is a green organ.

11. A method according to claim 1, wherein the plant is an edible plant, preferably selected from the group consisting of herbs, broccoli, spinach, peas, and green bell pepper, and combinations thereof.

12. A method for preparation of a food composition, comprising preparing a vegetable material according to the method of claim 1;
wherein additionally the product from step b) is brought into contact with at least one food ingredient prior to step c),
and/or wherein the product from step c) is brought into contact with at least one food ingredient.

13. A method according to claim 12, wherein in step c) the heating is done in aqueous solution at a temperature between 60° C. and 150° C.

14. A vegetable material obtainable by the method according to claim 1.

15. A soup, a dressing, a beverage, a spread, or a herbal composition comprising the vegetable material according to claim 14.

16. (canceled)
